(19) United States
(12) Patent Application Publication
(10) Pub. No.: US 2023/0047513 A1
(43) Pub. Date: Feb. 16, 2023

(54) Operating Medium Feeding Arrangement

(71) Applicant: BHS Corrugated Maschinen- und Anlagenbau GmbH, Weiherhammer (DE)

(72) Inventor: Gerald ERL, Etzenricht (DE)

(21) Appl. No.: 17/794,325

(22) PCT Filed: Jan. 28, 2021
(86) PCT No.: PCT/EP2021/052039

§ 371 Date: Jul. 21, 2022

(30) Foreign Application Priority Data
Feb. 18, 2020 (DE) 10 2020 202 033.7

(51) Int. Cl. H02G 11/00; B65H 75/42; B65H 75/48; H02G 11/02; F16G 13/16

(52) U.S. Cl. CPC H02G 11/006; B65H 75/42; B65H 75/48; F16G 13/16; H02G 11/02

(57) ABSTRACT

The invention relates to an operating medium feeding arrangement for feeding at least one operating medium to a device, which is being conveyed by a conveying arrangement, to be assembled and/or set in operation. The operating medium feeding arrangement comprises an adjustable carrying device for carrying at least one supply line for connecting to the device.

### CROSS-REFERENCES TO RELATED APPLICATIONS

This application claims the priority of German Patent Application, Serial No. 10 2020 202 033.7, filed Feb. 18, 2020, the content of which is incorporated herein by reference in its entirety as if fully set forth herein.

### FIELD OF THE INVENTION

The invention relates to an operating medium feeding arrangement for feeding at least one operating medium, such as electrical energy, in particular current and/or voltage, gas, such as compressed air, water, hydraulic fluid or the like, to a device that is being conveyed by a conveying arrangement, which in particular is/becomes a component of a corrugated cardboard plant. The invention is further directed to a manufacturing plant for the manufacture of devices having at least one operating medium feeding arrangement of this type. Furthermore, the invention is directed to a method for feeding at least one operating medium to a device that is being conveyed by a conveying arrangement.

### BACKGROUND OF THE INVENTION

It is customary for the assembly and initial commissioning of devices to take place at fixed locations within an assembly hall. The devices and the tools required for this purpose are usually supplied with operating media via permanently installed supply lines. The disadvantage of this is that, on the one hand, assembly areas are predetermined. On the other hand, supply lines running on a hall floor often form dangerous tripping hazards.

### SUMMARY OF THE INVENTION

It is an object of the present invention to provide an operating medium feeding arrangement which, on the one hand, is particularly user-friendly and, on the other hand, allows for extremely efficient assembly or initial commissioning of devices. A corresponding manufacturing plant and a corresponding method shall also be provided.

The object is achieved according to the invention by an operating medium feeding arrangement for feeding at least one operating medium to a device which is being conveyed by a conveying arrangement and is to be assembled and/or set in operation, which device is in particular a component of a corrugated cardboard plant, comprising an adjustable carrying device for carrying at least one supply line for connecting to the device.

The object is further achieved by a manufacturing plant for manufacture of devices, which are in particular a component of a corrugated cardboard plant, having a conveying arrangement for conveying the devices, and having at least one operating medium feeding arrangement according to the invention.

The object is further achieved by a method for feeding at least one operating medium to a device conveyed by a conveying arrangement and to be assembled and/or set in operation, which device is in particular a component of a corrugated cardboard plant, comprising the steps of conveying the device by means of a conveying arrangement, and providing an operating medium feeding arrangement according to the invention.

The core of the invention is the adjustable carrying device, which is capable of carrying the at least one supply line and of guiding it towards the device to be supplied with operating medium while the latter is being conveyed. During operation, in particular, the carrying device establishes a connection between a source of operating medium and the device to be supplied with operating medium.

During assembly, the device is put together. Commissioning takes place, for example, especially at the manufacturer’s site, for a test run, an inspection, an adjustment of the device and/or its preparation for transport to a customer.

The at least one supply line is designed, for example, as a cable, tube, pipe or the like. It is expedient if the latter is flexible or bendable at least in some areas. It is advantageous if at least one delivery connection for connecting to the device and/or at least one intake connection for connecting to the operating medium source is connected to the at least one supply line. In use, the at least one supply line preferably runs, at least in some areas, inside and/or outside the carrying device.

The operating medium source is capable of delivering operating medium. For example, it is permanently integrated into a building, such as an assembly hall.

The carrying device is designed, for example, as a carrying arm device. It preferably comprises at least one guide for the at least one supply line. It is convenient if the carrying device comprises a connection part for the arrangement at a stationary element.

The device to be assembled or set in operation is preferably provided, in particular in a finished state, for a corrugated cardboard plant or for being used in a corrugated cardboard plant. It is, for example, an unwinding device for unwinding a material web, for example an endless material web, a device for producing a corrugated cardboard web that is laminated on one side, a glue application device for applying glue to a corrugated web, a heating and pressing device for producing a corrugated cardboard web that is laminated on both sides, or a device for cutting a material web or corrugated cardboard web in its longitudinal and/or transverse direction. Alternatively, the finished device is used in a technical sector other than the corrugated cardboard sector, such as sheet metal working.

It is expedient if the manufacturing plant comprises a plurality of operating medium feeding arrangements which are arranged at a distance from one another in a conveying direction of the conveying arrangement and are preferably of identical design.

The carrying device comprising a horizontally adjustable adjusting mechanism for adapting to a respectively prevailing distance to the device while the device is being conveyed is in particular capable of varying its dimension or extension, such as its length, in the horizontal or in a horizontal plane, for example, between 1 m and 8 m. In particular, it is capable of assuming a dimension or extension in the horizontal that (substantially) corresponds to a respective distance between the operating medium source, the at least one intake connection or the connecting part and the device being conveyed. The adjusting mechanism preferably has a minimum effective working length, for example between 1 m and 3 m, when the device is located adjacent to the operating medium source, the at least one intake connection or the connecting part. If, on the other hand, the device is located at a distance from the operating medium source, the at least one intake connection or the connecting part, the adjusting mechanism preferably has a greater effective working length. With increasing distance of the device from the operating medium source, the at least one intake connection or the connecting part, the dimension or extension of the adjusting mechanism in the horizontal direction preferably also increases. As a result, the operating medium feeding arrangement can be used continuously, for example, over several workstations or working areas. This makes it possible to transport or take along operating media.

The embodiment, in which the adjusting mechanism is designed as a telescopic mechanism, results in an adjustment mechanism which is particularly functionally reliable and user-friendly. The telescopic mechanism comprises several telescopic elements, for example between 2 and 10, preferably between 3 and 7, which are displaceable, in particular in a guided manner, between a fully pushed-in position and a maximum pulled-out position. In a pushed-in position, the telescopic elements are pushed into one another at least in some areas, while in a pulled-out position they are pulled out at least in some areas.

The at least one linear bearing for supporting at least one telescopic element leads to a particularly simple adjustment or length variation of the telescopic mechanism in the horizontal, which is particularly user-friendly. An extremely low-backlash and precise guidance is also possible in this way. It is expedient if the at least one linear bearing comprises rolling elements, such as balls, cylinders, needles, cones, barrels or the like. It is advantageous if the at least one linear bearing is a component of at least one linear guide or straight guide.

The design, in which the adjusting mechanism is capable of adjusting itself independently when the device is being conveyed, is extremely user-friendly. With the operating medium feeding arrangement connected to the device, the adjusting mechanism adjusts automatically while/by conveying the device and thus adapts autonomously to the respective distance prevailing between the operating medium source, the at least one intake connection or the connecting part and the device. The device preferably takes the operating medium feeding arrangement or adjusting mechanism with it while conveying the device. In doing so, it is advantageous if the adjusting mechanism shifts in the horizontal, such as swivels, in particular swivels freely. The adjusting mechanism is preferably capable of adjusting itself without a motor or drive.

The return mechanism for returning the adjusting mechanism to a zero position when the carrying device is uncoupled from the device, wherein preferably the return mechanism comprises at least one return spring element, again leads to a particularly user-friendly operating medium feeding arrangement. It is thus superfluous to return the adjusting mechanism manually from its respective connection position to the zero position. It is convenient if the at least one return spring element is designed as a spring block or spring, such as a gas spring, hydraulic spring, metallic spring or the like. Advantageously, the return mechanism tensions when the adjusting mechanism is displaced from its zero position and generates a return force.

The operating medium feeding arrangement, in which at least one rotatably mounted winding roll for winding up and/or unwinding at least one supply line is arranged on the carrying device, is particularly user-friendly and brings about a particularly high level of work safety. It is also extremely efficient. Preferably, several winding rolls are provided for different supply lines for different operating media. Advantageously, the winding rolls have different core diameters and/or axial core widths, in particular depending on the associated supply line. It is expedient if the free unwound length of the at least one supply line in use (essentially) depends on the respective prevailing dimension or extension of the adjusting mechanism in the horizontal.

The embodiment, in which at least one resetting mechanism for resetting the at least one winding roll, wherein the at least one resetting mechanism is associated with the at least one winding roll, also results in a particularly user-friendly operating medium feeding arrangement. The at least one resetting mechanism comprises, for example, at least one resetting spring element, which is configured, for example, as a metallic spring. Advantageously, the resetting mechanism tensions when the supply line that is wound up there is unwound and generates a resetting force.

The embodiment, in which the carrying device comprises an, in particular steplessly, at least partially vertically adjustable adapting mechanism for vertical adaptation to the device, results in an operating medium feeding arrangement that can be readily used with different devices, in particular with different heights. The adjusting mechanism is at least partially height-adjustable in the vertical or a vertical plane. It is designed, for example, as an adjusting arm mechanism. It is expedient if the adapting mechanism comprises at least one vertically adjustable adapting element, which preferably supports the at least one delivery connection, for example at the bottom, and is vertically adjustable by, for example, 1 m to 3 m. It is advantageous if the adapting mechanism and the adjusting mechanism can be releasably coupled to each other. They preferably extend (substantially) perpendicularly to each other when being coupled.

The embodiment, in which a holding hoist, in particular a holding wire rope hoist, for holding the adapting mechanism or an adapting element thereof in a parking position when the carrying device is uncoupled, is particularly user-friendly. When the adapting mechanism or its adapting element is in a parking position, it is not in the way. The parking position is preferably an uppermost position of the adapting device or adapting element.

The pull-down means for pulling down the adapting mechanism and/or the adapting element from the parking position preferably extends downward from the adapting mechanism. It is preferably flexible and designed as a rope, chain, belt, band or the like. Alternatively, it is, for example, rigid and designed as a rod, pipe or the like. It is preferably readily accessible by a standing operator.

The at least one handle arranged at the carrying device for adjusting the carrying device allows a simple and targeted manual adjustment of the carrying device to the device. It is expedient if at least one handle is/are arranged at the adjusting mechanism and/or the adapting mechanism.

The swivel joint part arranged at the carrying device for articulated connection of the carrying device to a stationary element is preferably a component of a swivel joint which permits swiveling of the adjusting mechanism, in particular horizontally, with the conveyed device, preferably over a swiveling range between 90° and 170°, preferably between 120° and 170°. The swivel joint provides a swivel axis which advantageously extends vertically. It has one degree of freedom. The stationary element is, for example, a component of a building that is housing the manufacturing plant, such as a wall, floor, ceiling, column, beam or the like. It is capable of mounting/supporting the operating medium feeding arrangement.

The connecting joint part, in particular a joint head, arranged at the carrying device for articulated connection of the carrying device to the device, is preferably a component of a connecting joint which permits adaptation of the carrying device to the device to be supplied with operating media, in particular its position on the conveying arrangement or its height. It is convenient if the connecting joint part that is arranged at the carrying device has a sphere-like shape. A corresponding joint socket or ball socket is preferably arranged at the device. The connecting joint allows for a mechanical connection between the carrying device and the device.

The advantages of a manufacturing plant according to the invention also relate to preferred further development of a method for feeding at least one operating medium to a device conveyed by a conveying arrangement and to be assembled and/or set in operation, which device is in particular a component of a corrugated cardboard plant, comprising the steps of conveying the device by means of a conveying arrangement, and providing an operating medium feeding arrangement (6) according to the invention.

In the following, a preferred embodiment of the invention is described by way of example with reference to the enclosed drawing.

### BRIEF DESCRIPTION OF THE DRAWING

FIG. 1 shows a perspective view of a sub-area of a manufacturing plant having a device to be set in operation in a first working area and an operating medium feeding arrangement mechanically connected thereto, which is in a fully pulled-out position,

FIG. 2 shows a side view of the manufacturing plant shown in FIG. 1,

FIG. 3 shows a top view onto a sub-area of the manufacturing plant shown in FIGS. 1, 2, wherein the device has been conveyed further in a conveying direction into a further working area compared with FIGS. 1, 2, and the operating medium feeding arrangement is in a pushed-in zero position,

FIG. 4 shows a top view of a sub-section of the manufacturing plant shown in FIGS. 1, 2, wherein the device has been conveyed further in the conveying direction into a further working area compared with FIG. 3, and the operating medium feeding arrangement is in a fully pulled-out position,

FIG. 5 shows an enlarged cut-out which illustrates a mechanical connection of the operating medium feeding arrangement to the device,

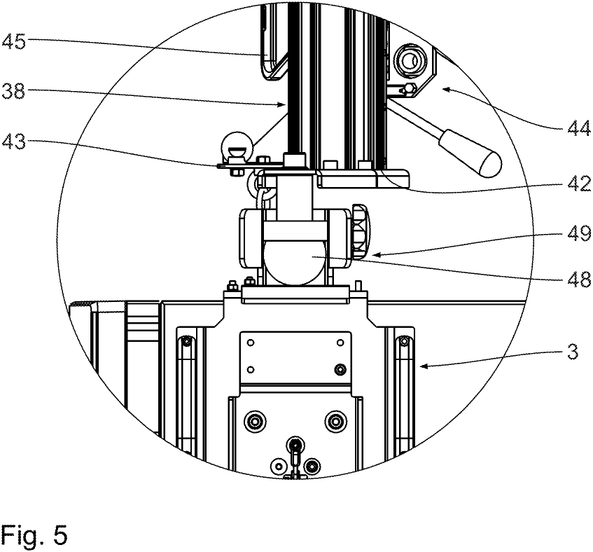

FIG. 6 shows a view of the operating medium feeding arrangement similar to FIG. 3, wherein the device not shown for the sake of clarity,

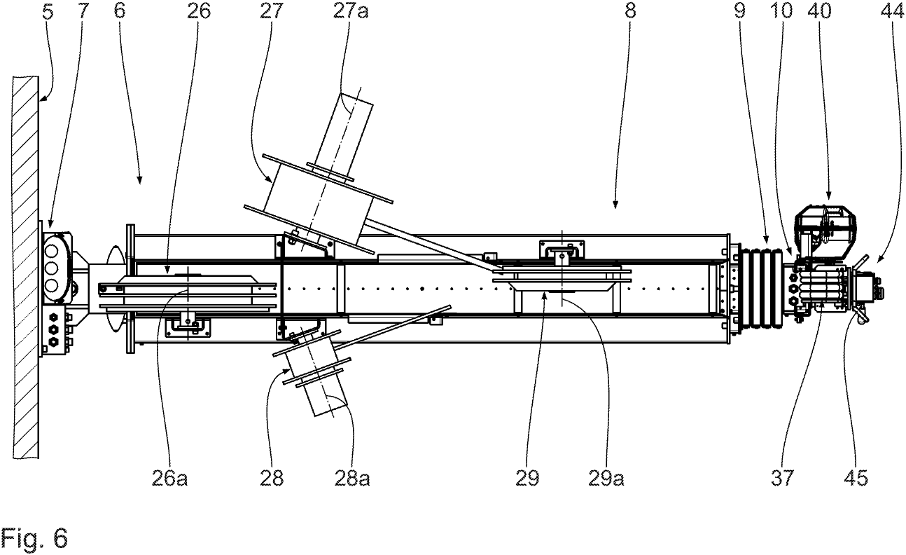

FIG. 7 shows a side view of the operating medium feeding arrangement shown in FIG. 6,

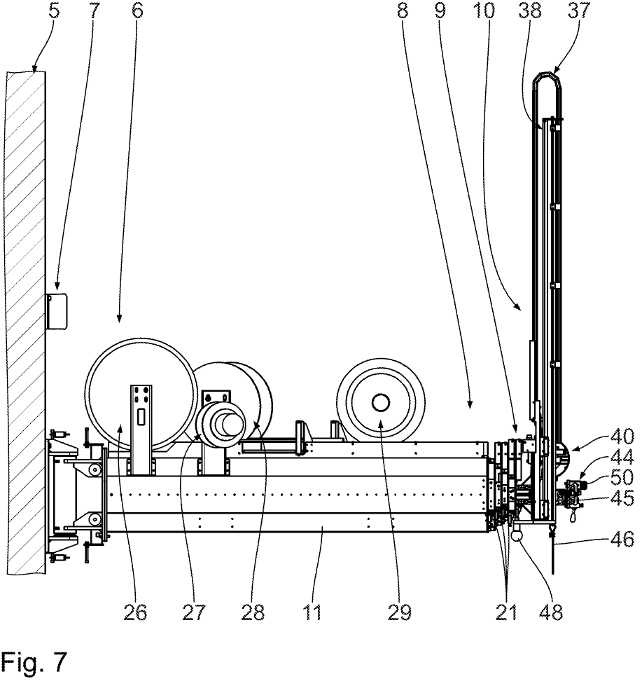

FIG. 8 shows a cross-section through an adjusting mechanism of the illustrated operating medium feeding arrangement,

FIG. 9 shows a longitudinal section through the operating medium feeding arrangement shown in FIGS. 6, 7,

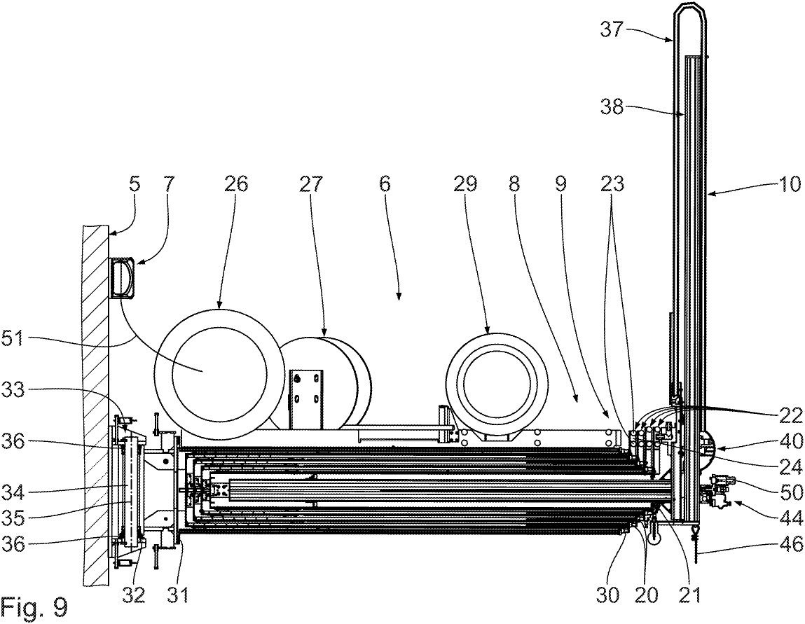

FIG. 10 shows a perspective view of the adapting mechanism of the operating medium feeding arrangement shown in FIGS. 6, 7, which is decoupled, and

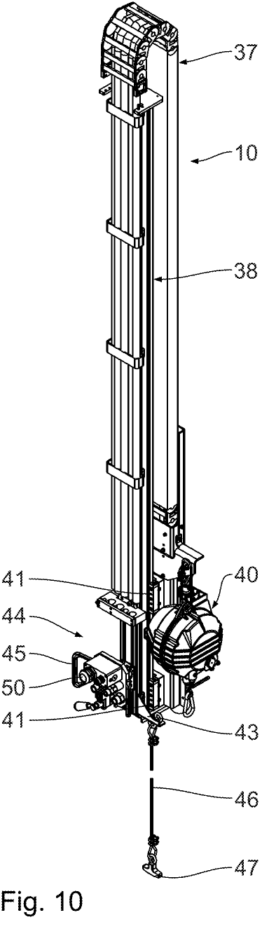

FIG. 11 shows a side view of the adapting mechanism shown in FIG. 10 with a fully pulled-out adapting element

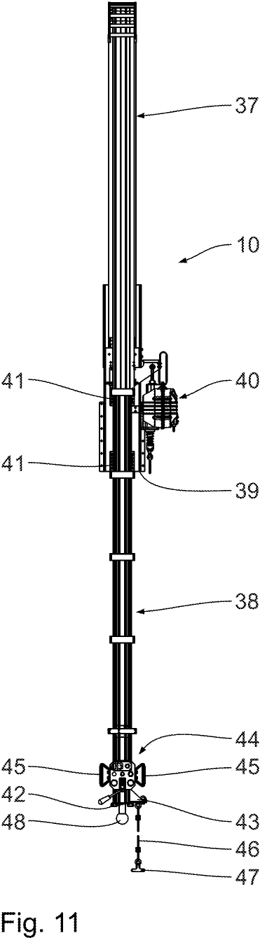

### DESCRIPTION OF THE PREFERRED EMBODIMENT

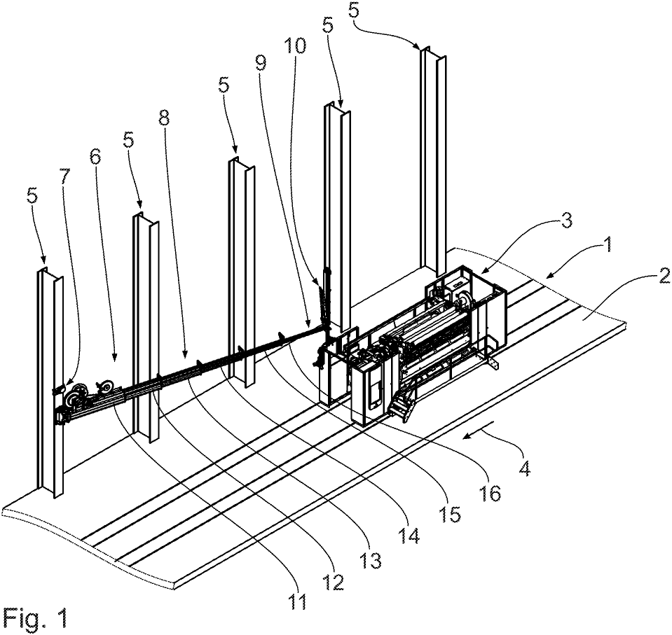

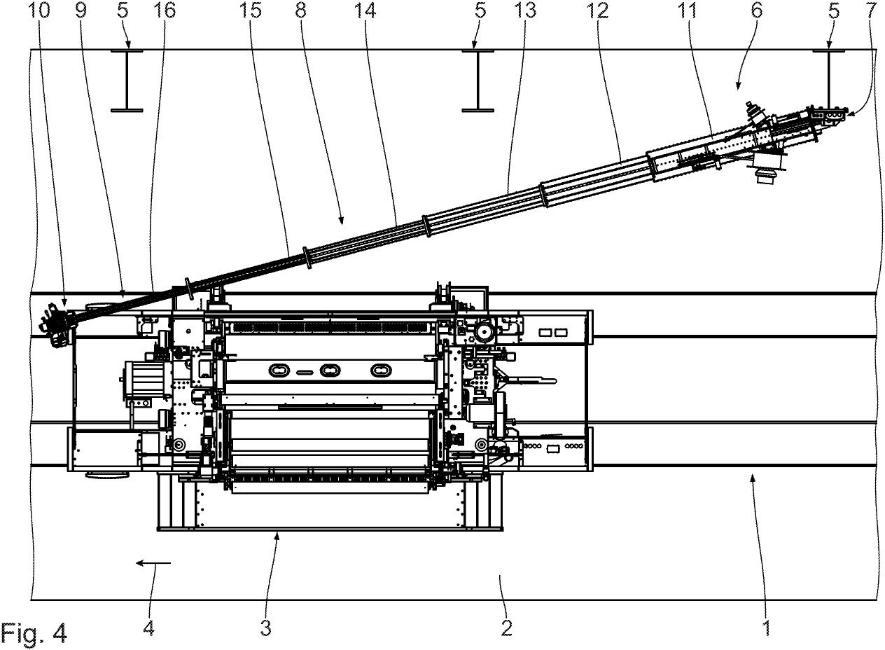

A manufacturing plant that is partially shown in FIGS. 1 to 4 comprises a conveyor rail system 1 which is supported by a floor 2 of an assembly hall (not shown). The conveyor rail system 1 is arranged on or embedded in the floor 2, for example. It extends horizontally and straightforward. Devices 3 can be conveyed along the conveyor rail system 1 in a conveying direction 4. The devices 3 can be conveyed past working areas which are spaced apart in the conveying direction 4. The devices 3 can be conveyed in the conveying direction 4, preferably by means of a drive. They are, for example, of identical design or differ from one another.

A plurality of beams 5 are firmly connected to the floor 2, which beams extend vertically adjacent to the conveyor rail system 1 and are spaced apart in the conveying direction 4. The beams 5 are stationary or fixed with respect to the assembly hall.

As FIG. 1 shows, an operating medium feeding arrangement 6 is arranged at a beam 5 at a distance from the floor 2. The beams 5 that are arranged adjacent to this beam 5 are free from operating medium feeding arrangements 6.

The beam 5 that is supporting the operating medium feeding arrangement 6 also carries a coupling unit 7 having different coupling means which are in direct or indirect connection, such as electrically conductive or fluidic, with different operating medium sources.

The operating medium feeding arrangement 6 has an adjustable carrying device 8. The carrying device 8 in turn comprises a boom-like adjusting arm mechanism 9 and an adapting mechanism 10, which is in fixed connection with the adjusting arm mechanism 9 in the coupled state.

The adjusting arm mechanism 9 is designed as a telescopic mechanism. It has a plurality of telescopic elements 11 to 16, which in principle have identical cross-sectional shapes but different transverse dimensions.

The telescopic element 11 which is the largest in cross-section forms an outer telescopic element when the telescope device is pushed together. It is housing-like. The telescopic element 16 which is the smallest in cross-section forms an innermost telescopic element when the telescopic mechanism is pushed together. The remaining telescopic elements 12 to 15 form intermediate telescopic elements and are open on both sides. The outer telescopic element 11 is capable of accommodating the remaining telescopic elements 12 to 16. The innermost telescopic element 16 is then located completely inside and is surrounded laterally by the remaining telescopic elements 11 to 15. The outer telescopic element 11 is made of steel for the sake of stability, while the remaining telescopic elements 12 to 16 are made of aluminum for weight reasons.

With the exception of the innermost telescopic element 16, each telescopic element 11 to 15 is formed by a cross-shaped hollow profile. The innermost telescopic element 16 is formed by a profiled body.

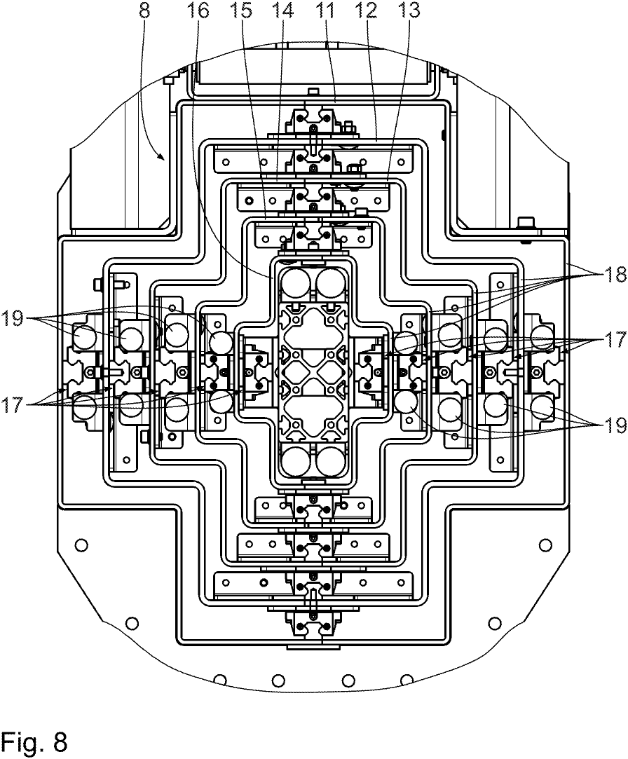

The telescopic elements 11 to 16 extend along a common longitudinal axis at a horizontal distance from the floor 2. As FIG. 8 shows, two opposing linear guides 17 are arranged in each case between two telescopic elements 11 to 16 that are arranged adjacent to one another. With the exception of the innermost telescopic element 16, each telescopic element 11 to 15 supports two horizontally extending rail bodies on the inside. The rail bodies are attached in pairs to opposing inner sides of vertically extending side walls 18 of the respective telescopic element 11 to 15. Each linear guide 17 further comprises spherical rolling bodies 19 which are capable of rolling on the associated rail bodies and which are arranged above and below the same. The rolling bodies 19 are mounted as to be rotatable on the telescopic elements 12 to 15 that are arranged on the inside of the rail bodies.

Each linear guide 17 extends horizontally, in particular at least over a major part of the horizontal length of the telescopic element 11 to 15 carrying it. The linear guides 17 permit linear guidance and displacement of the telescopic element 12 to 16 that is arranged on the inside of the respective linear guide 17. A reversed arrangement of rail bodies and rolling bodies 19 is alternatively possible.

With the exception of the innermost telescopic element 16, each telescopic element 11 to 15 carries, adjacent to its front end 20 that is facing the adapting mechanism 10, in each case a pair of rollers 21 at the bottom, the running axes of which run horizontally and perpendicularly to a longitudinal axis of the adjusting arm mechanism 9. Each roller 21 supports the adjacent telescopic element 12 to 16, which is the next smaller telescopic element in cross-section and is thus capable of running down there.

A supply line guide 22 is arranged at the top of each telescopic element 11 to 16 adjacent to its front end 20. Each supply line guide 22 comprises two guiding rods 23, which are arranged spaced apart one above the other to form a respective gap-like passage opening 24 for at least one supply line 25 and run parallel to one another. The guiding rods 23 extend horizontally and perpendicularly to the longitudinal axis of the adjusting arm mechanism 9.

Four winding rolls 26, 27, 28, 29 are arranged on the outside of the outer telescopic element 11. Each winding roll 26, 27, 28, 29 has a horizontally extending winding axis 26a, 27a, 28a and 29a, respectively. The winding rolls 26, 27, 28, 29 differ from each other, for example, in their core diameter. The core diameter of each winding roll 26, 27, 28, 29 depends in particular on an outer diameter of the supply line 25 provided for this winding roll 26, 27, 28, 29.

The winding roll 26, which forms a first winding roll, for example, has the largest core diameter. Its winding axis 26a extends perpendicularly to the longitudinal axis of the adjusting arm mechanism 9.

The winding roll 27, which forms a second winding roll, has a smaller core diameter but a larger axial core width than the first winding roll 26. Its winding axis 27a extends obliquely to the longitudinal axis of the adjusting arm mechanism 9. The second winding roll 27 is offset forward in the direction of the front end 20 compared with the first winding roll 26.

The winding roll 28, which forms a third winding roll, has a smaller core diameter and a smaller axial core width than the second winding roll 27. Its winding axis 28a extends obliquely to the longitudinal axis of the adjusting arm mechanism 9. The third winding roll 28 is offset forward in the direction of the front end 20 compared with the first winding roll 26. It has a distance to the front end 20 which corresponds to the distance of the second winding roll 27 to the front end 20.

The winding roll 29, which forms a fourth winding roll, has a core diameter similar to or equal to the core diameter of the second winding roll 27. Its axial core width is smaller than the axial core width of the second winding roll 27. Its winding axis 29a extends perpendicularly to the longitudinal axis of the adjusting arm mechanism 9. The fourth winding roll 29 is offset forward in the direction of the front end 20 in comparison with the second winding roll 27.

The second and third winding rolls 27, 28 are each arranged laterally offset to a vertical main plane of the adjusting arm mechanism 9. The vertical main plane runs between the second and third winding rolls 27, 28. The first and fourth winding rolls 26, 29 are arranged laterally offset from one another perpendicularly to the longitudinal axis of the adjusting arm mechnism 9.

A resetting spring mechanism is assigned to each winding roll 26, 27, 28, 29. Each resetting spring mechanism engages the associated winding roll 26, 27, 28 or 29 and applies a winding force to the respective winding roll 26, 27, 28 or 29 in a respective winding direction when the supply line 25 is at least partially unwound.

Each telescopic element 11 to 15, with the exception of the innermost telescopic element 16, also carries at least one buffer element 30 adjacent to its respective front end 20.

Opposite its front end 20, the outer telescopic element 11 carries a vertically extending end plate 31, to which in turn a vertically extending joint bushing 32 is firmly connected.

A holder 33 is attached to the beam 5 that is carrying the operating medium feeding arrangement 6, on the side facing the conveyor rail system 1. A cylindrical retaining bolt 34 is arranged in the holder 33, which retaining bolt extends vertically. The retaining bolt 34 passes through the joint bushing 32. The joint bushing 32 together with the adjusting arm mechanism 9 can be pivoted about the retaining bolt 34 and a vertical pivot axis 35. The joint bushing 32 is mounted so that it can pivot accordingly via rolling bearings 36. The joint bushing 32 and the retaining bolt 34 are components of a swivel joint. A reversed arrangement of the joint bushing 32 and the retaining bolt 34 is alternatively possible.

A return spring mechanism acts between the beam 5 that is carrying the operating medium feeding arrangement 6 and the adjusting arm mechanism 9. This return spring mechanism forces the adjusting arm mechanism 9 into a neutral zero position when the operating medium feeding arrangement 6 is not in use. In the zero position, the adjusting arm mechanism 9 extends perpendicularly to an adjacent section of the conveyor rail system 1 or to the conveying direction 4 there.

In the coupled state, the adapting mechanism 10 is connected to the innermost telescopic element 16. In doing so, the adapting mechanism 10 is connected to the front end 20 of the innermost telescopic element 16.

The adapting mechanism 10 includes a housing-like outer part 37 and an inner part 38. The outer part 37 and/or inner part 38 can be designed in several parts. The outer part 37 and the inner part 38 are linearly adjustable vertically relative to one another.

The outer part 37 extends vertically when coupled and is connected to the front end 20 of the innermost telescopic element 16. Adjacent to its lower end 39, the outer part 37 carries a holding wire rope hoist 40 having spring reset. The holding wire rope hoist 40 is capable of retaining the adapting mechanism 10 or the inner member 38 in an uncoupled, i.e. free, state in an upper parking position.

In the parking position, the inner part 38 is located at least for the most part within the outer part 37. It can then be displaced vertically downwards out of the outer part 37. For this purpose, the adapting mechanism 10 comprises linear guides 41. A reverse displacement upwards into the parking position is also possible.

The inner part 38 carries an end plate 43 at its lower end 42, which end plate 43 extends horizontally.

Adjacent to the end plate 43 or adjacent to the lower end 42, a handle assembly 44 having two handles 45 is disposed on the inner part 38.

From the end plate 43, a pull-down cable 46 having a handle portion 47 for pulling down the inner part 38 or pulling it out of the outer part 37 when the inner part 38 is in its upper parking position. The adapting mechanism 10 is thus extendable.

The end plate 43 also carries a spherical joint head 48 at the bottom. The joint head 48 is located below the end plate 43.

A joint socket 49 that is complementary to the joint head 48 is arranged, for example detachably, at the device 3 to be fed with operating medium. The joint head 48 and the joint socket 49 form a ball joint when coupled. The ball joint has three degrees of freedom.

In the following, the use of the operating medium feeding arrangement 6 is described in more detail.

A device 3 to be fed with operating medium is conveyed in the conveying direction 4 via the conveyor rail system 1. This device 3 is followed by further devices 3, which are also to be fed with operating medium, but are not shown. The conveying of the device(s) 3 can take place with or without stops. Devices 3 to be assembled are conveyed in the same way.

Workstations or working areas are arranged one after the other adjacent to the conveyor rail system 1 in the order of the required working steps.

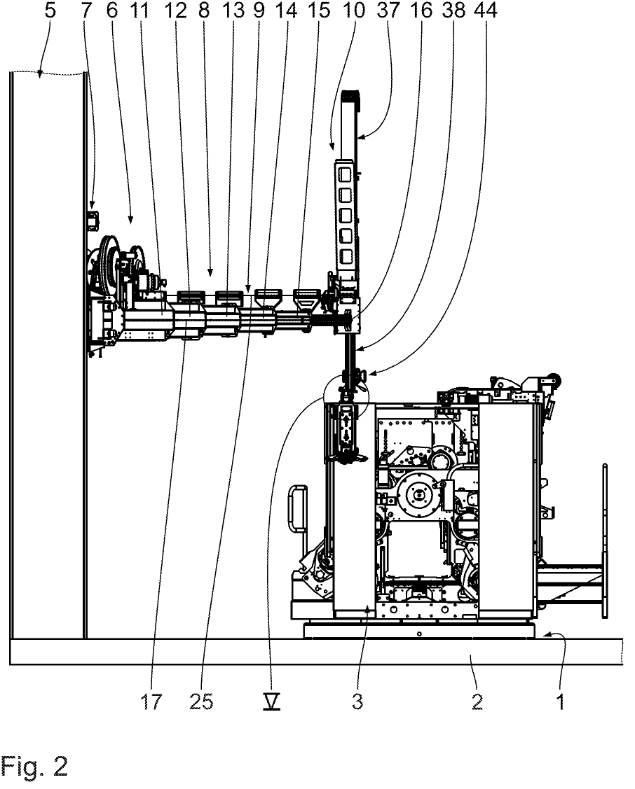

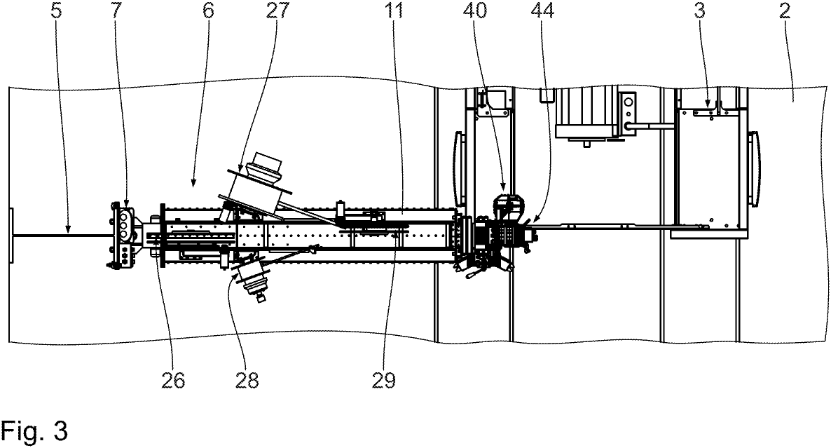

When the device 3 that is to be supplied with operating medium reaches an initial feeding area of the shown operating medium feeding arrangement 6 on the conveyor rail system 1, the adjusting arm mechanism 9 is manually pivoted about the vertical pivot axis 35 from the zero position shown in FIG. 3 to the device 3 (FIGS. 1, 2), for connecting the operating medium feeding arrangement 6 to this device 3. The adjusting arm mechanism 9 then extends from the beam 5 carrying said adjusting arm mechanism 9 in the opposite direction to the conveying direction 4. It then preferably has a maximum length, wherein its telescopic elements 12 to 16 are extended accordingly. The swiveling of the operating medium feeding arrangement 6 takes place against the return spring mechanism, which is preferably tensioned in the process. During swiveling, an operator preferably grips the handles 45.

The inner part 38 is also pulled vertically downward out of the outer part 37 via the handle portion 47 for connecting the operating medium feeding arrangement 6 to the device. The joint head 48 is inserted from above into the joint socket 49 arranged at the device 3. The joint head 48 is retained in the joint socket 49. An unintended separation between the joint head 48 and the joint socket 49 is prevented. The operating medium feeding arrangement 6 and the device 3 are thus mechanically coupled to one another.

Subsequently, the supply line(s) 25 required for the necessary working step(s) is/are unwound from the respective winding roll 26, 27, 28 or 29, wherein the respective winding roll 26, 27, 28 or 29 rotates about its respective winding axis 26a, 27a, 28a or 29a and the respectively associated resetting spring mechanism is tensioned. During this process, the supply line(s) 25 is/are also displaced relative to the supply line guides 22 of the adjusting arm mechanism 9 and supply line guides of the adapting mechanism 10. They are then connected to the device 3. Each supply line 25 has a corresponding delivery connection 50 for this purpose, so that the device 3 is capable of receiving the necessary operating medium(s). Each supply line 25 communicates with the coupling unit 7 via an intake connection 51 to receive the necessary operating medium, for example from a tank, a piping system, an electrical wiring system or the like. The operation medium(s) thus pass(es) from the operating medium source via the respective supply line 25 to the device 3. Each supply line 28 extends at a distance from the floor 2. The device 3 is located in a first working area.

When the device 3 continues to move on the conveyor rail system 1 in the conveying direction 4, it approaches the beam 5 carrying the operating medium feeding arrangement 6. In the process, the adjusting arm mechanism 9 is pivoted about the pivot axis 35 in the direction of the zero position of the operating medium feeding arrangement 6 due to the conveying of the device 3. At the same time, the adjusting arm mechanism 9 is pushed together. The buffer elements 30 prevent damage to the telescopic elements 11 to 16 when they are pushed together. When the device 3 is adjacent to the beams 5 carrying the operating medium feeding arrangement 6, the adjusting arm mechanism 9 assumes a zero position. The adjusting arm mechanism 9 then extends perpendicularly to the conveying direction 4. In the zero position, it assumes a minimum length. The device 3 is further capable of receiving operating medium. The device 3 thus moves to a next working area.

When the device 3 is conveyed further in the conveying direction 4, the adjusting arm mechanism 9 pivots further about the pivot axis 35. The adjusting arm mechanism 9 extends again. The adjusting arm mechanism 9 extends from the beam 5 that is carrying the operating medium feeding arrangement 6 in the conveying direction 4. The device 3 is still capable of receiving operating medium. The device 3 moves to a next working area. Further working areas to the indicated working areas are possible.

When the feeding area of the operating medium feeding arrangement 6 is left, the operating medium feeding arrangement 6 must be uncoupled again from the device 3 together with the supply line(s) 25. The inserted winding roll(s) 26, 27, 28 or 29 automatically roll(s) up in a winding direction. The adjusting arm mechanism 9 automatically moves back to its zero position.

Subsequently, another operating medium feeding arrangement 6 can be connected to the device 3, if necessary.

1. An operating medium feeding arrangement for feeding at least one operating medium to a device which is being conveyed by a conveying arrangement and is at least one of to be assembled and set in operation, comprising
a) an adjustable carrying device for carrying at least one supply line for connecting to the device.

2. The operating medium feeding arrangement according to claim 1, wherein the carrying device comprises a horizontally adjustable adjusting mechanism for adapting to a respectively prevailing distance to the device while the device is being conveyed.

3. The operating medium feeding arrangement according to claim 17, wherein the adjusting mechanism is designed as a telescopic mechanism.

4. The operating medium feeding arrangement according to claim 3, wherein the adjusting mechanism comprises at least one linear bearing for supporting at least one telescopic element.

5. The operating medium feeding arrangement according to claim 17, wherein the adjusting mechanism is capable of adjusting itself independently when the device is being conveyed.

6. The operating medium feeding arrangement according to claim 17, further comprising a return mechanism for returning the adjusting mechanism to a zero position when the carrying device is uncoupled from the device.

7. The operating medium feeding arrangement according to claim 1, wherein at least one rotatably mounted winding roll for at least one of winding up and unwinding at least one supply line is arranged on the carrying device.

8. The operating medium feeding arrangement according to claim 7, further comprising at least one resetting mechanism for resetting the at least one winding roll wherein the at least one resetting mechanism is associated with the at least one winding roll.

9. Theoperating medium feeding arrangement according to claim 1, wherein the carrying device comprises an at least partially vertically adjustable adapting mechanism for vertical adaptation to the device.

10. The operating medium feeding arrangement according to claim 9, further comprising a holding hoist for holding the adapting mechanism or an adapting element thereof in a parking position when the carrying device is uncoupled.

11. The operating medium feeding arrangement according to claim 10, further comprising characterized by a pull-down means for pulling down at least one of the adapting mechanism and the adapting element from the parking position.

12. The operating medium feeding arrangement according to claim 1, further comprising at least one handle arranged at the carrying device for adjusting the carrying device.

13. The operating medium feeding arrangement according to claim 1, further comprising a swivel joint part arranged at the carrying device for articulated connection of the carrying device to a stationary element.

14. The operating medium feeding arrangement according to claim 1, further comprising a connecting joint part arranged at the carrying device for articulated connection of the carrying device to the device.

15. A manufacturing plant for manufacture of devices comprising
a) a conveying arrangement for conveying the devices and
b) at least one operating medium feeding arrangement for feeding at least one operating medium to a device which is being conveyed by a conveying arrangement and is at least one of to be assembled and to be set in operation, comprising
an adjustable carrying device for carrying at least one supply line for connecting to the device.

16. A method for feeding at least one operating medium to a device conveyed by a conveying arrangement and to be at least one of assembled and set in operation, the method comprising the steps of:
conveying the device by means of a conveying arrangement and
providing an operating medium feeding arrangement for feeding at least one operating medium to a device which is being conveyed by a conveying arrangement and is at least one of to be assembled and to be set in operation, the operating medium feeding arrangement comprising
an adjustable carrying device for carrying at least one supply line for connecting to the device.

17. The operating medium feeding arrangement according to claim 1, wherein the device is a component of a corrugated cardboard plant.

18. The operating medium feeding arrangement according to claim 6, wherein the return mechanism comprises at least one return spring element.

19. The operating medium feeding arrangement according to claim 11, wherein the adapting mechanism is steplessly adjustable.

20. The operating medium feeding arrangement according to claim 10, wherein the holding hoist is a holding wire rope hoist.

21. The operating medium feeding arrangement according to claim 14, wherein the connecting joint part is a joint head.

22. The manufacturing plant for manufacture of devices according to claim 15, wherein the device is a component of a corrugated card-board plant.

23. The method according to claim 16, wherein the device is a component of a corrugated cardboard plant.
